(19) United States
(12) Patent Application Publication
(10) Pub. No.: US 2026/0004487 A1
(43) Pub. Date: Jan. 1, 2026

(54) USER APPEARANCE MODIFICATION FOR VIDEO COMMUNICATION

(71) Applicant: Motorola Mobility LLC, Chicago, IL (US)

(72) Inventors: Amit Kumar Agrawal, Bangalore (IN); Rahul Bharat Desai, Hoffman Estates, IL (US)

(73) Assignee: Motorola Mobility LLC, Chicago, IL (US)

(21) Appl. No.: 18/755,922

(22) Filed: Jun. 27, 2024

(51) Int. Cl. G06T 11/60; G06V 40/16

(52) U.S. Cl. CPC G06T 11/60; G06V 40/16

(57) ABSTRACT

Techniques for user appearance modification for video communication are described. For instance, the described techniques can be implemented to detect that input user appearance data for a video communication exceeds a threshold variation from defined user appearance data associated with a user profile. The input user appearance data can be modified based at least in part on the defined user appearance data to generate modified user appearance data, and the modified user appearance data can be output as part of the video communication.

### BACKGROUND

Today's person is afforded a tremendous selection of devices that are capable of performing a multitude of tasks. For instance, desktop and laptop computers provide computing power and screen space for productivity and entertainment tasks. Further, smartphones and tablets provide computing power and communication capabilities in highly portable form factors. One particularly useful task involves online video communication between different users, such as video calls that enable different communication modalities including audio communication, video communication, content sharing, etc.

### BRIEF DESCRIPTION OF THE DRAWINGS

Aspects of user appearance modification for video communication are described with reference to the following Figures. The same numbers may be used throughout to reference similar features and components that are shown in the Figures. Further, identical numbers followed by different letters reference different instances of features and components described herein:

FIG. 1 illustrates an example environment 100 in which aspects of user appearance modification for video communication can be implemented.

FIG. 2 illustrates a system 200 for implementing aspects of user appearance modification for video communication in accordance with aspects of the present disclosure.

FIG. 3 illustrates a system 300 for implementing aspects of user appearance modification for video communication in accordance with aspects of the present disclosure.

FIG. 4 illustrates a flow chart depicting an example method 400 for user appearance modification for video communication in accordance with one or more implementations.

FIG. 5 illustrates a flow chart depicting an example method 500 for user appearance modification for video communication in accordance with one or more implementations.

FIG. 6 illustrates a flow chart depicting an example method 600 for user appearance modification for video communication in accordance with one or more implementations.

FIG. 7 illustrates an example scenario 700 for user appearance modification for video communication in accordance with one or more implementations.

FIG. 8 illustrates various components of an example device 800 in which aspects of user appearance modification for video communication can be implemented.

### DETAILED DESCRIPTION

Techniques for user appearance modification for video communication are described. For instance, the described techniques can be implemented to modify and/or generate user images for video communication between different users.

As an example, consider a scenario where a user receives a last minute invitation to attend an urgent early morning video call, such as for a work-related matter. The user has just awoken and has not had time to prepare for the video call, e.g., has not had time to groom themself for the video call. Thus, a live video stream of the user may reflect a visual appearance that is undesirable to the user. Accordingly, the described techniques enable a modified user appearance to be generated to represent the user for the video call, such as to present a more desirable image of the user for the video call.

In implementations, to generate the modified user appearance, defined user appearance data can be generated and stored. For instance, during previous video calls and/or based on stored user images, image data of the user can be collected and used to generate a defined user appearance of the user. The defined user appearance, for example, represents a visual appearance of the user that the user wishes to use for different video communications. The defined user appearance can be generated in different ways, such as automatically by system functionality and/or via user input to identify and/or approve the defined user appearance.

Accordingly, the system can compare a live video image of the user (e.g., in a visually unkempt state) to the defined user appearance and determine that the live video image exceeds a threshold visual variation from the defined user appearance. As further detailed below, for example, the threshold visual variation can be based on different visual attributes such as hair state (e.g., messy hair vs. neat hair), facial features (e.g., unshaven vs. neatly shaven, red eyes vs. clear eyes, skin tone variations, etc.), clothing state (e.g., unprofessional clothing vs. professional clothing), etc. Based at least in part on detecting the threshold visual variation, the system can generate a modified user appearance for use as part of the video call. The system can generate the modified user appearance in different ways, such as by visually modifying visual attributes of the live video image to more closely match the defined user appearance and/or by replacing some or all visual attributes of the live video image with visual attributes of the defined use appearance. Thus, the modified user appearance can be utilized to visually represent the user in the video call. For instance, the modified user appearance can be transmitted to client devices of other participants in the video call to visually represent the user to the other participants.

Various aspects of implementations described herein can leverage artificial intelligence (AI) functionality (e.g., AI and/or machine learning algorithms, AI and/or machine learning models, etc.) to detect user appearance variations and to generate modified user appearance. As discussed herein, the terms “AL” and “machine learning” can be used to refer to machine-implemented intelligence for performing various tasks on data, such as data analysis, data classification, data modification, data generation, etc. For instance, AI functionality can be used for user image classification, such as to determine whether input user image data (e.g., a live video feed of the user) exceeds a threshold variation from defined user appearance data. Further, AI functionality can be used to visually modify input user image data and/or to generate user image data that more closely visually resembles define user appearance data. The described implementations can utilize different types of AI models, such as classifier models, generative models, prediction models, combinations thereof, etc.

Accordingly, the described techniques can provide improvements to video communication, such as by automatically recognizing visual variations in user appearance data and automatically generating modified user appearance data for video communication.

While features and concepts of user appearance modification for video communication can be implemented in any number of environments and/or configurations, aspects the described techniques are described in the context of the following example systems, devices, and methods. Further, the systems, devices, and methods described herein are interchangeable in various ways to provide for a wide variety of implementations and operational scenarios.

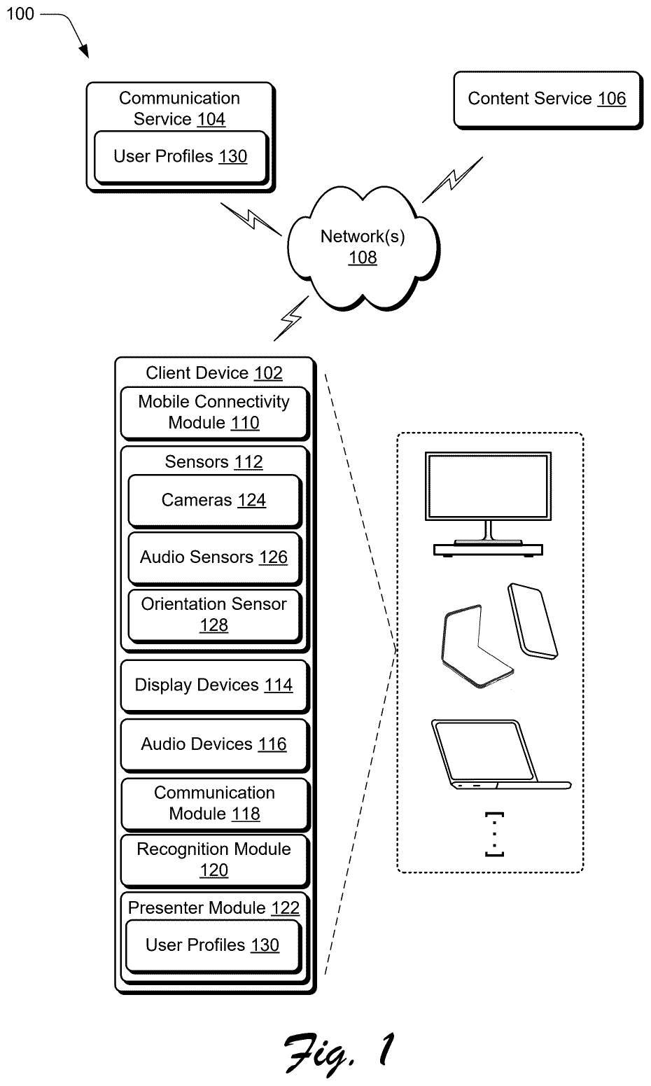

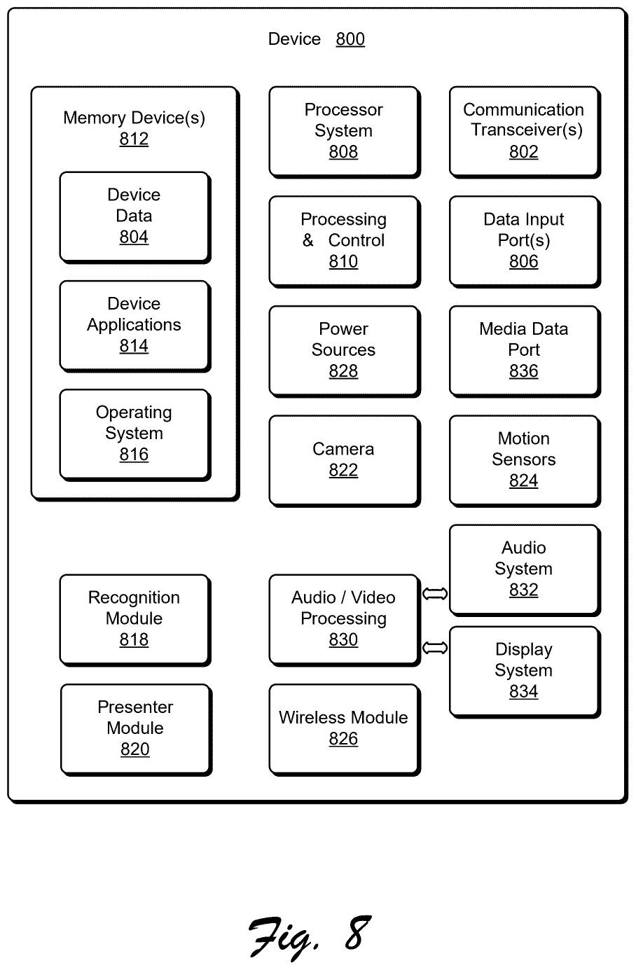

FIG. 1 illustrates an example environment 100 in which aspects of user appearance modification for video communication can be implemented. The environment 100 includes a client device 102, a communication service 104, and a content service 106 that are interconnectable via network(s) 108. The client device 102 can be implemented in various ways, such as a mobile device (e.g., a smartphone), a mobile foldable device (e.g., a foldable smartphone, a foldable tablet device), a laptop computing device, a desktop computing device, and so forth. Example attributes of the client device 102 are discussed below with reference to the device 800 of FIG. 8.

The client device 102 includes various functionality that enables the client device 102 to perform different aspects of user appearance modification for video communication discussed herein, including a mobile connectivity module 110, sensors 112, display devices 114, audio devices 116, a communication module 118, a recognition module 120, and a presenter module 122. The mobile connectivity module 110 represents functionality (e.g., logic and hardware) for enabling the client device 102 to interconnect with other devices and/or networks, such as the network 108. The mobile connectivity module 110, for instance, enables wireless and/or wired connectivity of the client device 102.

The sensors 112 are representative of functionality to detect various physical and/or logical phenomena in relation to the client device 102, such as motion, light, image detection and recognition, time and date, position, location, touch detection, sound, temperature, and so forth. Examples of the sensors 112 include hardware and/or logical sensors such as an accelerometer, a gyroscope, a camera, a microphone, a clock, biometric sensors, touch input sensors, position sensors, environmental sensors (e.g., for temperature, pressure, humidity, and so on), geographical location information sensors (e.g., Global Positioning System (GPS) functionality), and so forth. In this particular example the sensors 112 include cameras 124, audio sensors 126, and an orientation sensor 128. The sensors 112, however, can include a variety of other sensor types in accordance with the implementations discussed herein.

The display devices 114 represent functionality for outputting visual content via the client device 102. As further detailed below, for instance, the client device 102 includes multiple display devices 114 that can be leveraged for outputting content. The audio devices 116 represent functionality for providing audio output for the client device 102. In at least one implementation the client device 102 includes audio devices 116 positioned at different regions of the client device 102, such as to provide for different audio output scenarios. The communication module 118 represents functionality for performing different communication tasks via the client device 102, such as for engaging in communication with other devices. The communication module 118, for instance, represents a portal for interfacing with the communication service 104, such as for enabling communication (e.g., video calls, call sessions, etc.) between users of different devices.

The recognition module 120 represents functionality for recognizing objects detected by the sensors 112. For instance, utilizing video data captured by the cameras 124, the recognition module 120 can recognize visual objects present in the video data, such as a person. Various other types of sensor data may additionally or alternatively be used, such as audio data captured by the audio sensor 126. The presenter module 122 represents functionality for performing various aspects pertaining to user appearance modification for video communication in accordance with various implementations. For instance, and as further detailed below, the presenter module 122 is operable to configure and/or adapt presentation of media content and call sessions by the client device 102, such as based on user appearance data detected via camera 124.

The presenter module 122 maintains and/or has access to user profiles 130 which represent various information (e.g., data) about users associated with the client device 102. The user profiles 130, for instance, include data that visual attributes of different users as well as defined (e.g., preferred) visual appearance attributes of the different users. As further described herein, for instance, the user profiles 130 can be utilized to modify a visual appearance of a user, such as in conjunction with a video communication implemented via the communication module 118.

The communication service 104 may also maintain and/or have access to user profiles 130, implementations of which are described above. For instance, the communication service 104 may utilize the user profiles 130 to perform various aspects of user appearance modification for video communication described herein.

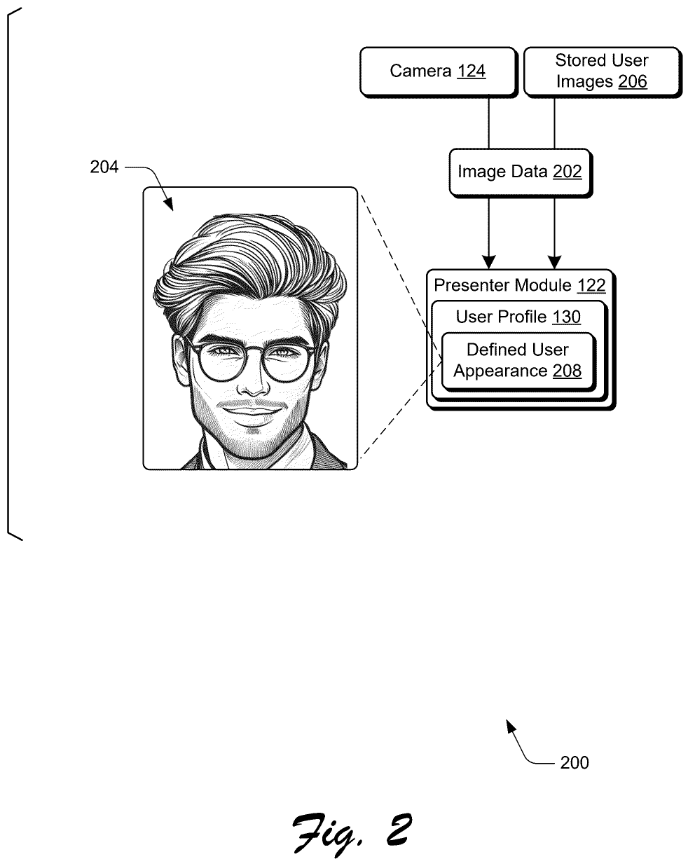

FIG. 2 illustrates a system 200 for implementing aspects of user appearance modification for video communication in accordance with aspects of the present disclosure. In the system 200 the presenter module 122 receives image data 202 for a user 204, such as from a camera 124 and/or stored user images 206. The image data 202, for instance, can be generated by the camera 124 based on live captured images of the user 204. In at least one implementation the image data 202 can represent images of the user 204 captured over time, such as during a video communication session and/or multiple communication sessions. Alternatively or additionally, the image data 202 can be generated from images of the user 204 stored as part of the stored user images 206.

The presenter module 122 utilizes the image data 202 to generate a defined user appearance 208 and stores the defined user appearance 208 as part of a user profile 130 for the user 204. The defined user appearance 208, for instance, represents image data that is generated based at least in part on the image data 202, such as via image data from the camera 124 and/or the stored user images 206. In at least one implementation the defined user appearance 208 represents a default, baseline, and/or preferred user visual appearance for the user 204. The defined user appearance 208 can be generated in various ways, such as based on individual images of the user 204 and/or via compositing of multiple images of the user 204. Further, in at least one implementation the defined user appearance 208 can be generated in response to user input to select a preferred user appearance and/or to modify (e.g., perform graphics editing to) a user image to generate the defined user appearance 208.

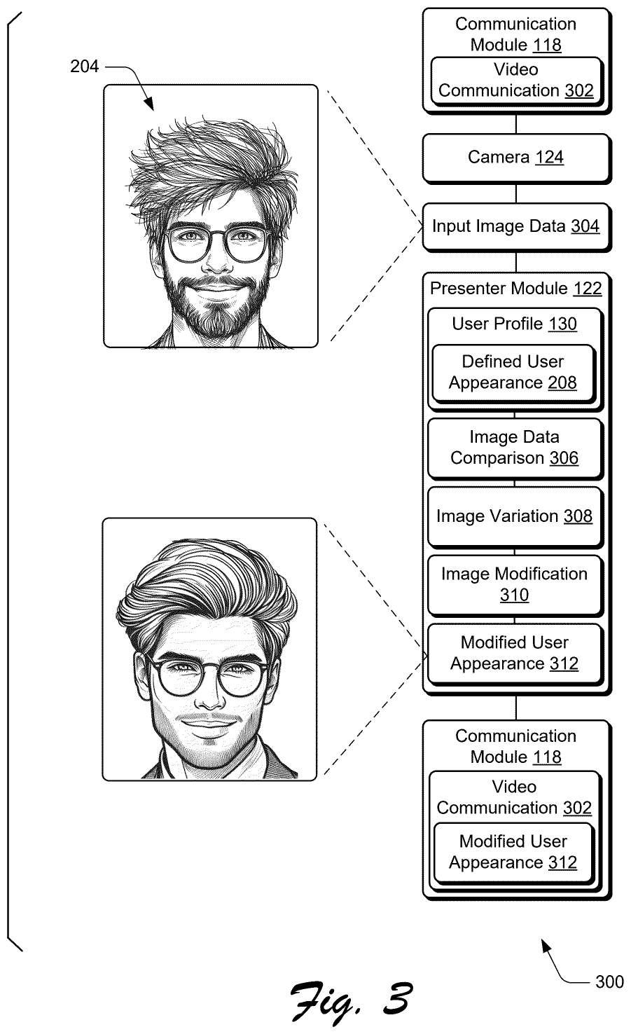

FIG. 3 illustrates a system 300 for implementing aspects of user appearance modification for video communication in accordance with aspects of the present disclosure. The system 300, for instance, can be implemented in conjunction with the system 200. In the system 300 a video communication 302 is implemented via the communication module 118. The communication module 118, for instance, represents a communication application and the video communication 302 represents a communication session that includes video features, such as a video call involving multiple different users at different locations. The video communication 302 may include one or more other communication modalities, such as audio content, content sharing (e.g., file sharing), etc.

In conjunction with the video communication 302, a camera 124 captures input image data 304 of the user 204. The input image data 304, for instance, represents a “live” and/or “real time” image of the user 204. The presenter module 122 receives the input image data 304 and performs image data comparison 306 based at least in part on comparing the input image data 304 to the defined user appearance 208. Various visual attributes of the input image data 304 can be compared to visual attributes of the defined user appearance 208, such as hair state (e.g., hair appearance and/or hair shape), facial appearance (e.g., skin color tone, facial hair state (e.g., shaven, unshaven, etc.), eye state (e.g., eye color such as eye redness, skin color around eyes, eye drooping, etc.), mouth state (e.g., yawning), etc.

Accordingly, based at least in part on the image data comparison 306, the presenter module 122 determines that an image variation 308 occurs that indicates that the input image data 304 exceeds a threshold visual variation from the defined user appearance 208. For instance, with reference to the hair state of the user 204, the image variation 308 can indicate that a visual appearance of the user's hair in the input image data 304 varies a threshold amount from a visual appearance of the user's hair in the defined user appearance 208.

As another example, the image variation 308 can indicate that facial features reflected in the input image data 304 varies a threshold amount from facial features reflected in the defined user appearance 208. For instance, the image data comparison 306 indicates that in the defined user appearance 208 the user 204 is neatly shaven whereas the input image data 304 reflects an unshaven appearance of the user 204. Further, the image data comparison 306 can indicate that skin tone (e.g., color tone) of the user 204 reflected in the input image data 304 varies a threshold amount from a skin tone reflected in the defined user appearance 208. The image variation 308 may additionally or alternatively be based on other visual features, such as variations in eye appearance (e.g., eye redness vs. clear eyes), eyewear (e.g., glasses, no glasses), clothing (e.g., unprofessional clothing vs. professional clothing), etc.

Accordingly, based at least in part on detecting the image variation 308, the presenter module 122 performs image modification 310 to generate a modified user appearance 312. The modified user appearance 312 can be generated in different ways, such as by modifying and/or replacing visual attributes of the input image data 304. For instance the user's hair can be visually modified to provide a visual appearance of neat hair, the user's face can be visually modified to appear neatly shaven and/or to perform skin tone correction to more closely reflect the skin tone of the defined user appearance 208, and/or the user's clothing can be visually modified to reflect more “professional” clothing, etc. Alternatively or additionally to visual modification of the input image data 304, visual attributes of the input image data 304 can be partially or completely replaced with visual attributes of the defined user appearance 208 to generate the modified user appearance 312.

The modified user appearance 312 can be communicated to the communication module 118 for use as part of the video communication 302. For instance, the modified user appearance 312 can be used as a real time representation of the user 204 during the video communication 302. In at least one implementation the modified user appearance 312 can be animated during the video communication 302, such as reflect movement of the user 204 and to reflect mouth movement of the user 204 when the user 204 speaks as part of the video communication 302. The modified user appearance 312, for example, can be output as a visually dynamic representation of the user 204 to simulate user motion of the user 204.

As described above, different operations of the presenter module 122 and/or the communication module 118 can be performed using AI functionality, such as one or more AI classifier models for performing the image data comparison 306 to determine the image variation 308, and/or one or more AI generative models to perform the image modification 310.

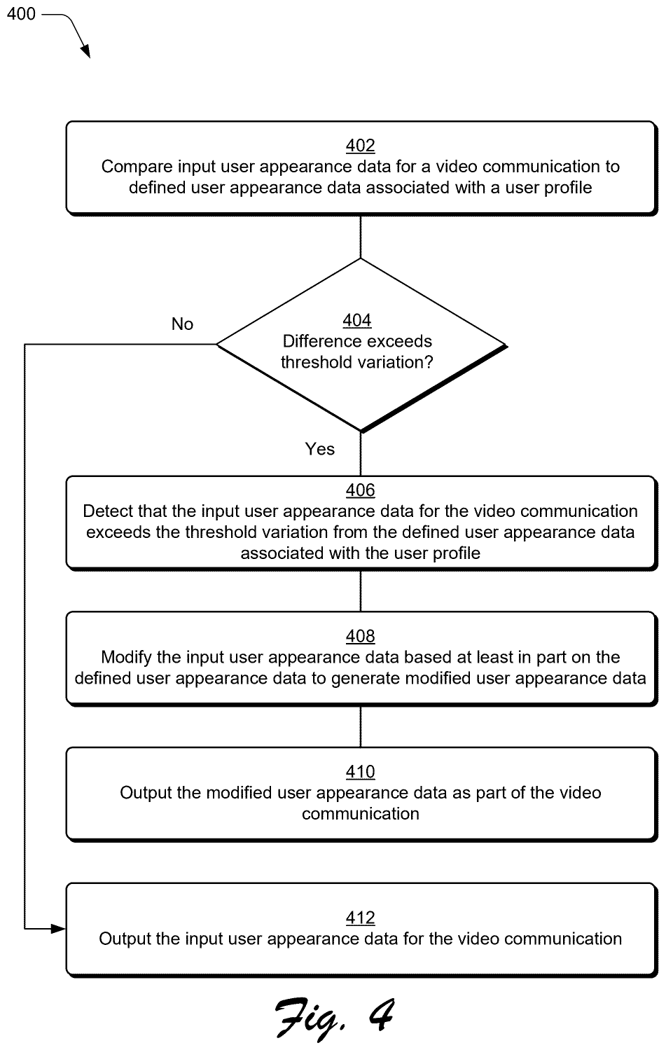

FIG. 4 illustrates a flow chart depicting an example method 400 for user appearance modification for video communication in accordance with one or more implementations. At 402 input user appearance data for a video communication is compared to defined user appearance data associated with a user profile. The presenter module 122, for instance, compares visual attributes extracted from the input image data to corresponding visual attributes from defined user appearance data. Different examples of visual attributes are described throughout this disclosure. At 404 it is determined whether a difference between the user appearance data and the defined user appearance data exceeds a threshold variation.

The presenter module 122, for example, can generate a first digital representation (e.g., first binary mapping) of different portions of the defined user appearance data, such as of hair features, facial features, clothing features, etc., of the defined user appearance data. The presenter module 122 can also generate a second digital representation (e.g., second binary mapping) of different portions of the input user appearance data, such as of hair features, facial features, clothing features, etc., of the input user appearance data. The presenter module 122 can compare the second digital representation to the first digital representation to determine a variation of visual features of the second digital representation from corresponding visual features of the first digital representation, such as to determine a visual variation of the input user appearance data from the defined user appearance data.

At 404 it is determined whether a difference between the input user appearance data and the defined user appearance data exceeds a threshold variation. The threshold variation, for example, can be based on visual attributes of the defined user appearance data and the input user appearance data, such as hair appearance, facial feature appearance, clothing appearance, etc. If the difference between the input user appearance data and the defined user appearance data exceeds the threshold variation (“Yes”), at 406 it is detected that input user appearance data for the video communication exceeds the threshold variation from the defined user appearance data associated with the user profile.

At 408 the input user appearance data is modified based at least in part on the defined user appearance data to generate modified user appearance data. Different ways for modifying the input user appearance data are described throughout this disclosure, such as by performing visual modification of visual features of the input user appearance data and/or by replacing some or all visual features of the input user appearance data with corresponding visual features of the defined user appearance data.

At 410 the modified user appearance data is output as part of the video communication. The modified user appearance data, for example, is output to represent the user as part of the video communication, e.g., in place of the input user appearance data.

Returning to 404, if the difference between the input user appearance data and the defined user appearance data does not exceed the threshold variation (“No”), at 412 the input user appearance data is output for the video communication. The input user appearance data, for instance, is not modified and is output as part of the video communication as a representation of the user.

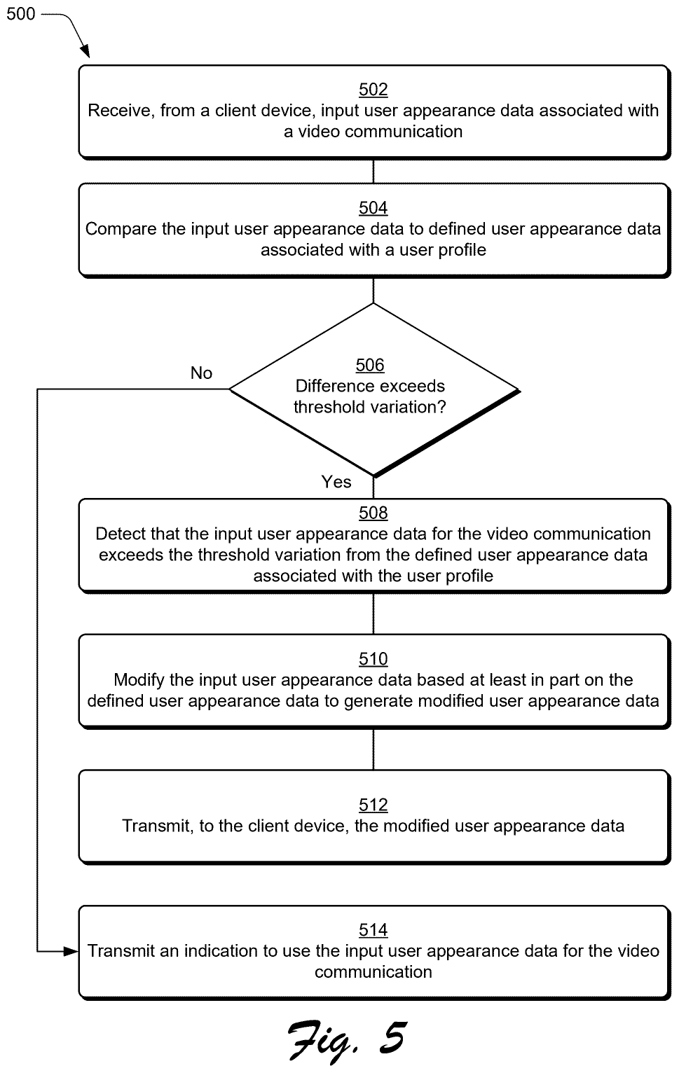

FIG. 5 illustrates a flow chart depicting an example method 500 for user appearance modification for video communication in accordance with one or more implementations. In at least one implementation various aspects of the method 500 are performed by a network-based service, such as the communication service 104. At 502 input user appearance data associated with a video communication is received from a client device. The communication service 104, for instance, receives the input user appearance data from the client device 102. In at least one implementation, in conjunction with transmitting the input user appearance data to the communication service 104, the client device 102 also indicates to the communication service 104 that a video communication is scheduled to start at a future time (e.g., in t minutes) or that a video communication has already started.

At 504 the input user appearance data is compared to defined user appearance data associated with a user profile. The communication service 104, for instance, compares visual attributes extracted from the input user appearance data to corresponding visual attributes from the defined user appearance data. Different examples of visual attributes are described above. At 506 it is determined whether a difference between the user appearance data and the defined user appearance data exceeds a threshold variation.

The communication service 104, for example, can generate a first digital representation (e.g., first binary mapping) of different portions of the defined user appearance data, such as of hair features, facial features, clothing features, etc., of the defined user appearance data. The communication service 104 can also generate a second digital representation (e.g., second binary mapping) of different portions of the input user appearance data, such as of hair features, facial features, clothing features, etc., of the input user appearance data. The communication service 104 can compare the second digital representation to the first digital representation to determine a variation of the second digital representation from the first digital representation, such as to determine a visual variation of the input user appearance data from the defined user appearance data.

At 506 it is determined whether a difference between the input user appearance data and the defined user appearance data exceeds a threshold variation. The threshold variation, for example, can be based on visual attributes of the defined user appearance data and the input user appearance data, such as hair appearance, facial feature appearance, clothing appearance, etc. If the difference between the input user appearance data and the defined user appearance data exceeds the threshold variation (“Yes”), at 508 it is detected that input user appearance data for a video communication exceeds a threshold variation from defined user appearance data associated with a user profile.

At 510 the input user appearance data is modified based at least in part on the defined user appearance data to generate modified user appearance data. Different ways for modifying the input user appearance data are described throughout this disclosure, such as by performing visual modification of visual features of the input user appearance data and/or by replacing some or all visual features of the input user appearance data with corresponding visual features of the defined user appearance data.

At 512 the modified user appearance data is transmitted to the client device. The communication service 104, for instance, transmits the modified user appearance data to the client device 102. Alternatively or additionally the communication service 104 can insert the modified user appearance data into the video communication, such as in conjunction with the communication service 104 managing and/or facilitating the video communication.

Returning to 506, if the difference between the input user appearance data and the defined user appearance data does not exceed the threshold variation (“No”), at 514 an indication is transmitted to use the input user appearance data for the video communication. The input user appearance data, for instance, is not modified and the communication service 104 can transmit a notification to the client device to use the input user appearance data for the communication session, e.g., that the input user appearance data is within a threshold similarity to the defined user appearance data. Alternatively or additionally the communication service 104 can insert the input user appearance data into the video communication, such as in conjunction with the communication service 104 managing and/or facilitating the video communication.

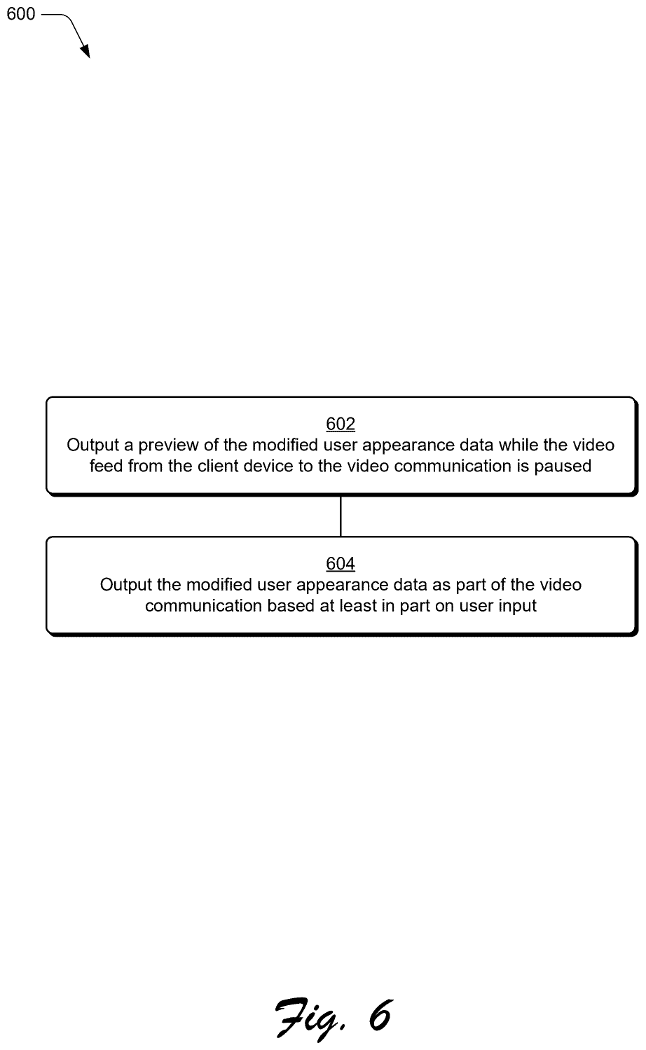

FIG. 6 illustrates a flow chart depicting an example method 600 for user appearance modification for video communication in accordance with one or more implementations. In at least one implementation various aspects of the method 600 can be performed by the client device 102 and/or a network-based service, such as the communication service 104. At 602 a preview of the modified user appearance data is output while the video feed from the client device to the video communication is paused. The client device 102 and/or the communication service 104, for instance, can pause (e.g., prevent output of) a video feed from the client device 102, such as while input user appearance data is in the process of being modified based at least in part on the defined user appearance data to generate modified user appearance data.

Further, the client device 102 and/or the communication service 104 can output a preview of the modified user appearance data, such as via the client device 102. In at least one implementation the preview can include selectable options to accept or decline the modified user appearance data. In response to user selection of the accept control, the client device 102 and/or the communication service 104 can cause the modified user appearance data to be output as part of the video communication. In response to user selection of the decline control, the client device 102 and/or the communication service 104 can prevent the modified user appearance data from being output as part of the video communication. In at least one implementation, in response to user selection of the decline control, the client device 102 and/or the communication service 104 can reprocess the input user appearance data to generate second modified user appearance data, such as based on second input user appearance data received after the initial user appearance data. The second modified user appearance data can be output as part of the video communication and/or a second preview of the second modified user appearance data can be output, such as to enable a user to accept or decline the second modified user appearance data, e.g., as described above with reference to the initial modified user appearance data.

At 604 the modified user appearance data is output as part of the video communication based at least in part on user input. For instance, the modified user appearance data and/or second modified user appearance data can be output by the client device 102 and/or the communication service 104 as part of the video communication. For example, the modified user appearance data and/or second modified user appearance data can be output by the client device 102 and/or the communication service 104 as part of the video communication and in response to user input to accept the modified user appearance data, e.g., user selection of an accept control.

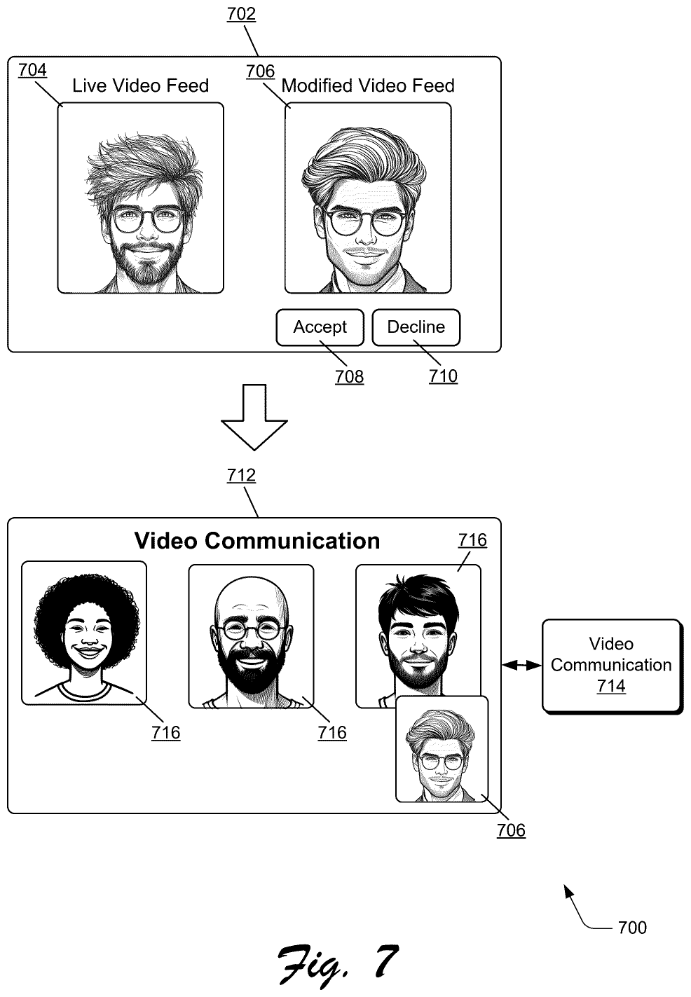

FIG. 7 illustrates an example scenario 700 for user appearance modification for video communication in accordance with one or more implementations. The scenario 700 includes an image modification GUI 702 that can be output by the client device 102 (e.g., by the communication module 118 and/or the presenter module 122) and/or via configuration of the image modification GUI 702 by the communication service 104 for output by the client device 102.

The image modification GUI 702 includes a live video feed 704 and a modified video feed 706. The live video feed 704, for example, represents real time captured video data, such as the input image data 304 captured by a camera 124 of the client device 102. For instance, the live video feed 704 represents unmodified video data captured by a camera 124. The modified video feed 706 represents video data that has been modified according to implementations described herein, e.g., the modified user appearance 312. The image modification GUI 702 also includes an accept control 708 and a decline control 710. The accept control 708, for example, is selectable by a user to cause the modified video feed 706 to be utilized for a video communication.

The decline control 710 can be selectable to decline using the modified video feed 706 for a video communication, e.g., to prevent the modified video feed 706 from being used for the video communication. User selection of the decline control 710 can cause various actions to be performed, such as using the live video feed 704 for the video communication and/or for reprocessing of the live video feed 704 to generate a further modified video feed for use as part of the video communication.

The scenario 700 further includes a video communication GUI 712 that can be output for a video communication 714, e.g., by the client device 102 and via the communication module 118. The video communication 714, for instance, represents a real time communication session that can involve various input/output modalities, such as video input/output, audio input/output, content sharing, etc. The video communication GUI 712 displays the modified video feed 706 (e.g., in response to user selection of the accept control 708) and further includes video images 716 of other participants in the video communication 714. According to implementations, the modified video feed 706 is transmitted to client devices of the other participants for presenting a visual representation of the user 204 on their respective client devices for the video communication 714.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 8 illustrates various components of an example device 800 in which aspects of user appearance modification for video communication can be implemented. The example device 800 can be implemented as any of the devices described with reference to the previous FIGS. 1-7, such as any type of client device, mobile phone, mobile device, wearable device, tablet, computing, communication, entertainment, gaming, media playback, and/or other type of electronic device. For example, the client device 102 as shown and described with reference to FIGS. 1-7 may be implemented as the example device 800.

The device 800 includes communication transceivers 802 that enable wired and/or wireless communication of device data 804 with other devices. The device data 804 can include any of device identifying data, device location data, wireless connectivity data, and wireless protocol data. Additionally, the device data 804 can include any type of audio, video, and/or image data. Example communication transceivers 802 include wireless personal area network (WPAN) radios compliant with various IEEE 802.15 (Bluetooth™) standards, wireless local area network (WLAN) radios compliant with any of the various IEEE 802.11 (Wi-Fi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 800 may also include one or more data input ports 806 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 800 includes a processing system 808 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 810. The device 800 may further include any type of a system bus or other data and command transfer system that couples the various components within the device. A system bus can include any one or combination of different bus structures and architectures, as well as control and data lines.

The device 800 also includes computer-readable storage memory 812 (e.g., memory devices) that enable data storage, such as data storage devices that can be accessed by a computing device, and that provide persistent storage of data and executable instructions (e.g., software applications, programs, functions, and the like). Examples of the computer-readable storage memory 812 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 800 may also include a mass storage media device.

The computer-readable storage memory 812 provides data storage mechanisms to store the device data 804, other types of information and/or data, and various device applications 814 (e.g., software applications). For example, an operating system 816 can be maintained as software instructions with a memory device and executed by the processing system 808. The device applications may also include a device manager, such as any form of a control application, software application, signal-processing and control module, code that is native to a particular device, a hardware abstraction layer for a particular device, and so on. Computer-readable storage memory 812 represents media and/or devices that enable persistent and/or non-transitory storage of information in contrast to mere signal transmission, carrier waves, or signals per se. Computer-readable storage memory 812 do not include signals per se or transitory signals.

In this example, the device 800 includes a recognition module 818 and a presenter module 820 that can implement aspects of user appearance modification for video communication and may be implemented with hardware components and/or in software as one of the device applications 814. For example, the recognition module 818 can be implemented as the recognition module 120 and the presenter module 820 can be implemented as the presenter module 122, described in detail above. In implementations, the recognition module 818 and/or the presenter module 820 may include independent processing, memory, and logic components as a computing and/or electronic device integrated with the device 800.

In this example, the example device 800 also includes a camera 822 and motion sensors 824, such as may be implemented in an inertial measurement unit (IMU). The motion sensors 824 can be implemented with various sensors, such as a gyroscope, an accelerometer, and/or other types of motion sensors to sense motion of the device. The various motion sensors 824 may also be implemented as components of an inertial measurement unit in the device.

The device 800 also includes a wireless module 826, which is representative of functionality to perform various wireless communication tasks. For instance, for the client device 102, the wireless module 826 can be leveraged to scan for and detect wireless networks, as well as negotiate wireless connectivity to wireless networks for the client device 102. The device 800 can also include one or more power sources 828, such as when the device is implemented as a mobile device. The power sources 828 may include a charging and/or power system, and can be implemented as a flexible strip battery, a rechargeable battery, a charged super-capacitor, and/or any other type of active or passive power source.

The device 800 also includes an audio and/or video processing system 830 that generates audio data for an audio system 832 and/or generates display data for a display system 834. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 836. In implementations, the audio system and/or the display system are integrated components of the example device. Alternatively, the audio system and/or the display system are external, peripheral components to the example device.

Although implementations of user appearance modification for video communication have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

In some aspects, the techniques described herein relate to a client device including: at least one memory; and at least one processor coupled with the at least one memory and configured to cause the client device to: detect that input user appearance data for a video communication exceeds a threshold variation from defined user appearance data associated with a user profile; modify the input user appearance data based at least in part on the defined user appearance data to generate modified user appearance data; and output the modified user appearance data as part of the video communication.

In some aspects, the techniques described herein relate to a client device, wherein the input user appearance data is based at least in part on image data of a user captured in real time.

In some aspects, the techniques described herein relate to a client device, wherein the at least one processor is configured to cause the client device to detect, prior to initiation of the video communication, that the input user appearance data for the video communication exceeds the threshold variation from the defined user appearance data.

In some aspects, the techniques described herein relate to a client device, wherein the at least one processor is configured to cause the client device to detect, based at least in part on the video communication being associated with an upcoming calendar event, that the input user appearance data for the video communication exceeds the threshold variation from the defined user appearance data.

In some aspects, the techniques described herein relate to a client device, wherein the at least one processor is configured to cause the client device to generate the defined user appearance data based at least in part on one or more of user appearance data captured during one or more previous video communications, user appearance data from one or more stored user images, or user input specifying a preferred visual appearance.

In some aspects, the techniques described herein relate to a client device, wherein the at least one processor is configured to cause the client device to detect, based at least in part on user camera preference data associated with a video application, that the input user appearance data for the video communication exceeds the threshold variation from the defined user appearance data.

In some aspects, the techniques described herein relate to a client device, wherein to modify the input user appearance data, the at least one processor is configured to cause the client device to perform visual modification of one or more visual features of the input user appearance data based at least in part on one or more corresponding visual features of the defined user appearance data.

In some aspects, the techniques described herein relate to a client device, wherein to modify the input user appearance data, the at least one processor is configured to cause the client device to perform visual replacement of one or more visual features of the input user appearance data with one or more corresponding visual features of the defined user appearance data.

In some aspects, the techniques described herein relate to a client device, wherein to detect that the input user appearance data for the video communication exceeds the threshold variation from the defined user appearance data associated with the user profile, the at least one processor is configured to cause the client device to one or more of: compare hair state data associated with the input user appearance data to hair state data associated with the defined user appearance data; compare facial feature data associated with the input user appearance data to facial feature data associated with the defined user appearance data; or compare clothing appearance data associated with the input user appearance data to clothing appearance data associated with the defined user appearance data.

In some aspects, the techniques described herein relate to a client device, wherein the at least one processor is configured to cause the client device to pause a video feed from the client device for the video communication until the modified user appearance data is generated.

In some aspects, the techniques described herein relate to a client device, wherein the at least one processor is configured to cause the client device to: output a preview of the modified user appearance data while the video feed from the client device to the video communication is paused; and output the modified user appearance data as part of the video communication based at least in part on user input.

In some aspects, the techniques described herein relate to a method performed by a client device, the method including: detecting that input user appearance data for a video communication exceeds a threshold variation from defined user appearance data associated with a user profile; modifying the input user appearance data based at least in part on the defined user appearance data to generate modified user appearance data; and outputting the modified user appearance data as part of the video communication.

In some aspects, the techniques described herein relate to a method, wherein modifying the input user appearance data includes at least one of: performing visual modification of one or more visual features of the input user appearance data based at least in part on one or more corresponding visual features of the defined user appearance data; or performing visual replacement of one or more visual features of the input user appearance data with one or more corresponding visual features of the defined user appearance data.

In some aspects, the techniques described herein relate to a system including: at least one memory; and at least one processor coupled to the at least one memory and configured to cause the system to: receive, from a client device, input user appearance data associated with a video communication; detect that the input user appearance data exceeds a threshold variation from defined user appearance data associated with a user profile; modify the input user appearance data based at least in part on the defined user appearance data to generate modified user appearance data; and transmit, to the client device, the modified user appearance data.

In some aspects, the techniques described herein relate to a system, wherein the at least one processor is configured to cause the system to generate the defined user appearance data based at least in part on one or more of user appearance data captured during one or more previous video communications, user appearance data from one or more stored user images, or user input specifying a preferred visual appearance.

In some aspects, the techniques described herein relate to a system, wherein the at least one processor is configured to cause system to detect, based at least in part on user camera preference data associated with a video application, that the input user appearance data for the video communication exceeds the threshold variation from the defined user appearance data.

In some aspects, the techniques described herein relate to a system, wherein to modify the input user appearance data, the at least one processor is configured to cause the system to perform visual modification of one or more visual features of the input user appearance data based at least in part on one or more corresponding visual features of the defined user appearance data.

In some aspects, the techniques described herein relate to a system, wherein to modify the input user appearance data, the at least one processor is configured to cause the system to perform visual replacement of one or more visual features of the input user appearance data with one or more corresponding visual features of the defined user appearance data.

In some aspects, the techniques described herein relate to a system, wherein to detect that the input user appearance data for the video communication exceeds the threshold variation from the defined user appearance data associated with the user profile, the at least one processor is configured to cause the system to one or more of: compare hair state data associated with the input user appearance data to hair state data associated with the defined user appearance data; compare facial feature data associated with the input user appearance data to facial feature data associated with the defined user appearance data; or compare clothing appearance data associated with the input user appearance data to clothing appearance data associated with the defined user appearance data.

In some aspects, the techniques described herein relate to a system, wherein the at least one processor is configured to cause the system to pause a video feed from the client device for the video communication until the modified user appearance data is generated.

What is claimed is:

1. A client device comprising:
at least one memory; and
at least one processor coupled with the at least one memory and configured to cause the client device to:
detect that input user appearance data for a video communication exceeds a threshold variation from defined user appearance data associated with a user profile;
modify the input user appearance data based at least in part on the defined user appearance data to generate modified user appearance data; and
output the modified user appearance data as part of the video communication.

2. The client device of claim 1, wherein the input user appearance data is based at least in part on image data of a user captured in real time.

3. The client device of claim 1, wherein the at least one processor is configured to cause the client device to detect, prior to initiation of the video communication, that the input user appearance data for the video communication exceeds the threshold variation from the defined user appearance data.

4. The client device of claim 1, wherein the at least one processor is configured to cause the client device to detect, based at least in part on the video communication being associated with an upcoming calendar event, that the input user appearance data for the video communication exceeds the threshold variation from the defined user appearance data.

5. The client device of claim 1, wherein the at least one processor is configured to cause the client device to generate the defined user appearance data based at least in part on one or more of user appearance data captured during one or more previous video communications, user appearance data from one or more stored user images, or user input specifying a preferred visual appearance.

6. The client device of claim 1, wherein the at least one processor is configured to cause the client device to detect, based at least in part on user camera preference data associated with a video application, that the input user appearance data for the video communication exceeds the threshold variation from the defined user appearance data.

7. The client device of claim 1, wherein to modify the input user appearance data, the at least one processor is configured to cause the client device to perform visual modification of one or more visual features of the input user appearance data based at least in part on one or more corresponding visual features of the defined user appearance data.

8. The client device of claim 1, wherein to modify the input user appearance data, the at least one processor is configured to cause the client device to perform visual replacement of one or more visual features of the input user appearance data with one or more corresponding visual features of the defined user appearance data.

9. The client device of claim 1, wherein to detect that the input user appearance data for the video communication exceeds the threshold variation from the defined user appearance data associated with the user profile, the at least one processor is configured to cause the client device to one or more of:
compare hair state data associated with the input user appearance data to hair state data associated with the defined user appearance data;
compare facial feature data associated with the input user appearance data to facial feature data associated with the defined user appearance data; or
compare clothing appearance data associated with the input user appearance data to clothing appearance data associated with the defined user appearance data.

10. The client device of claim 1, wherein the at least one processor is configured to cause the client device to pause a video feed from the client device for the video communication until the modified user appearance data is generated.

11. The client device of claim 10, wherein the at least one processor is configured to cause the client device to:
output a preview of the modified user appearance data while the video feed from the client device to the video communication is paused; and
output the modified user appearance data as part of the video communication based at least in part on user input.

12. A method performed by a client device, the method comprising:
detecting that input user appearance data for a video communication exceeds a threshold variation from defined user appearance data associated with a user profile;
modifying the input user appearance data based at least in part on the defined user appearance data to generate modified user appearance data; and
outputting the modified user appearance data as part of the video communication.

13. The method of claim 12, wherein modifying the input user appearance data comprises at least one of:
performing visual modification of one or more visual features of the input user appearance data based at least in part on one or more corresponding visual features of the defined user appearance data; or
performing visual replacement of one or more visual features of the input user appearance data with one or more corresponding visual features of the defined user appearance data.

14. A system comprising:
at least one memory; and
at least one processor coupled to the at least one memory and configured to cause the system to:
receive, from a client device, input user appearance data associated with a video communication;
detect that the input user appearance data exceeds a threshold variation from defined user appearance data associated with a user profile;
modify the input user appearance data based at least in part on the defined user appearance data to generate modified user appearance data; and
transmit, to the client device, the modified user appearance data.

15. The system of claim 14, wherein the at least one processor is configured to cause the system to generate the defined user appearance data based at least in part on one or more of user appearance data captured during one or more previous video communications, user appearance data from one or more stored user images, or user input specifying a preferred visual appearance.

16. The system of claim 14, wherein the at least one processor is configured to cause system to detect, based at least in part on user camera preference data associated with a video application, that the input user appearance data for the video communication exceeds the threshold variation from the defined user appearance data.

17. The system of claim 14, wherein to modify the input user appearance data, the at least one processor is configured to cause the system to perform visual modification of one or more visual features of the input user appearance data based at least in part on one or more corresponding visual features of the defined user appearance data.

18. The system of claim 14, wherein to modify the input user appearance data, the at least one processor is configured to cause the system to perform visual replacement of one or more visual features of the input user appearance data with one or more corresponding visual features of the defined user appearance data.

19. The system of claim 14, wherein to detect that the input user appearance data for the video communication exceeds the threshold variation from the defined user appearance data associated with the user profile, the at least one processor is configured to cause the system to one or more of:
compare hair state data associated with the input user appearance data to hair state data associated with the defined user appearance data;
compare facial feature data associated with the input user appearance data to facial feature data associated with the defined user appearance data; or
compare clothing appearance data associated with the input user appearance data to clothing appearance data associated with the defined user appearance data.

20. The system of claim 14, wherein the at least one processor is configured to cause the system to pause a video feed from the client device for the video communication until the modified user appearance data is generated.
